(19) United States
(12) Patent Application Publication
(10) Pub. No.: US 2008/0190506 A1
(43) Pub. Date: Aug. 14, 2008

(54) Fire resistant hose assembly

(76) Inventor: Rafael Cleveland, Orange Park, FL (US)

Correspondence Address: PARKER-HANNIFIN CORPORATION;HUNTER MOLNAR BAKER MORGAN, 6035 PARKLAND BOULEVARD, CLEVELAND, OH, 44124-4141, US

(21) Appl. No.: 11/799,593

(22) Filed: May 2, 2007

Related U.S. Application Data
(60) Provisional application No. 60/889,039, filed on Feb. 9, 2007.

(51) Int. Cl. F16L 11/12

(52) U.S. Cl. 138/110; 138/109; 138/151; 138/128

(57) ABSTRACT

An apparatus and method for forming a fire resistant hose assembly comprising a sleeve having a slit therein, through which a hose can be positioned in a manner providing easy assembly. The slit is sealed using an fire resistant adhesive. The slit can extend the entire length of the sleeve, or may be positioned spaced from one or both ends of the sleeve.

### CROSS REFERENCE TO RELATED APPLICATIONS

The present application claims the benefit of the filing date of U.S. Provisional Patent Application Ser. No. 60/889,039, filed Feb. 9, 2007, the disclosure of which is incorporated herein by reference.

### TECHNICAL FIELD

The present invention relates to fire resistant hose assemblies, and more particularly to a split fire resistant sleeve and hose wherein the hose is inserted into the slit of the sleeve after which the slit is sealed using an adhesive that also bonds the sleeve to the hose to form a fire resistant hose assembly.

### BACKGROUND OF THE INVENTION

Hose systems, particularly fuel, lubricating, and hydraulic hose, such as those used within aircraft engine compartments, often require fire resistant protection to minimize the likelihood of fire or high temperatures damaging the flexible elastomeric hose of the hydraulic circuits. Fire resistance is a term given its normal meaning in the art as capable of providing protection for a hose subjected to a fire for a specified period of time. Typically, resistance to fire and high temperature is achieved by encompassing the hose and portions of the associated hose fittings with a protective firesleeve. The firesleeve often consists of a silicone rubber tube surrounding the hose and/or fitting and the firesleeve usually includes an inner insulative material such as braided fiberglass.

Typically, firesleeve material is wound upon reels, and the firesleeve is cut to the desired length to accommodate the length of hose with which it is to be used. The firesleeve is a tube and is fit over the hose by threading one end of the hose into one end of the firesleeve and pulling the firesleeve over the hose. This may be a time consuming and difficult process, especially with longer lengths of hose. Lubrication and expander devices are typically required to assist in the process. Once the hose is inserted into the firesleeve, the hose may be able to rotate or axially move within the firesleeve as there is no direct connection between the firesleeve and the hose. Movement of the firesleeve may expose the hose to high temperatures or fire.

Another problem with prior art firesleeves is that they must be installed prior to installation of the fittings as the fittings will prevent the firesleeve from slipping over the ends of the hose. This, in turn, creates other problems such as a firesleeve providing an obstruction during the crimping operation of fitting attachment and may also be damaged during the crimping operation. This is especially problematic with short firesleeves. The firesleeve may also get in the way during leak-testing of the hose assembly or may cover a leaky fitting connection and prevent its detection.

A problem with firesleeves utilizing an insulative material such as braided fiberglass is that the cutting of the firesleeve to the desired length will expose the end of the firesleeve and the fibrous material thereof. Accordingly, it is required that the end of the firesleeve be treated or sealed with a silicone end dip so as to discourage contamination of the firesleeve's inner-fibrous material and prevent the “wicking” of moisture, fluids, or other liquids into the fibrous material by capillary action. Such processing of the ends of firesleeves is time consuming and may not produce a liquid impervious end seal.

Other prior art firesleeves are extruded directly to the hose, however these prior art firesleeves typically require additional protection to cover the fittings, such as cuffs.

Accordingly, there is a need in the art for a fire resistant hose assembly that overcomes at least one of the problems identified in the prior art.

### SUMMARY OF THE INVENTION

A particular embodiment of the invention includes a method for assembling a fire resistant hose assembly, comprising the steps of: slitting a tubular fire resistant sleeve lengthwise across the length of the sleeve; inserting a hose into the sleeve through the slit; applying a fire resistant adhesive along the length of the slit; applying pressure to the sleeve so that the sleeve completely surrounds the hose; and curing the adhesive.

At least one other particular embodiment of the invention includes a method for assembling a fire resistant hose assembly, comprising the steps of: slitting a tubular fire resistant sleeve lengthwise across at least a portion of the length of the sleeve; inserting a hose into the sleeve through the slit; and bonding the sleeve to the hose and sealing the slit closed so that the sleeve completely surrounds the hose using a fire resistant adhesive.

At least one other embodiment of the invention includes a fire resistant hose assembly comprising: a hose; an outer hose covering comprising a fire resistant sleeve having a slit lengthwise across at least a portion of the length of the sleeve, the sleeve positioned to completely surround the hose; wherein the outer hose covering is adhesively bonded to the hose, and the slit of the sleeve is adhesively sealed.

These and other advantages will be apparent upon review of the accompanying drawings and detailed description of the drawings discussed below.

### BRIEF DESCRIPTION OF THE DRAWINGS

Embodiments of this invention will now be described in further detail with reference to the accompanying drawings, in which:

FIG. 1 is a perspective view showing an embodiment of the split fire resistant sleeve of the present invention adjacent a standard hose assembly;

FIG. 2 is a perspective view of the sleeve of FIG. 1 being installed over the side of the hose shown in FIG. 1;

FIG. 3 is a perspective view of the hose positioned within the sleeve;

FIG. 4 is a perspective view of an adhesive being applied to the hose and the slit of the sleeve;

FIG. 5 is a perspective view of the hose and the sleeve assembly inserted into a mold;

FIG. 6 is a perspective view of an embodiment of the flame resistant hose assembly of the present invention;

FIG. 7 is a perspective view of another embodiment of the split fire resistant sleeve having a slit that is spaced from both ends of the sleeve;

FIG. 8 is a perspective view of another embodiment of the split fire resistant sleeve having two slits each spaced 180° apart and each slit spaced from both ends of the sleeve; and

FIG. 9 is a perspective view of another embodiment of the split fire resistant sleeve having a slit that is spaced from one end of the sleeve.

### DETAILED DESCRIPTION OF THE DRAWINGS

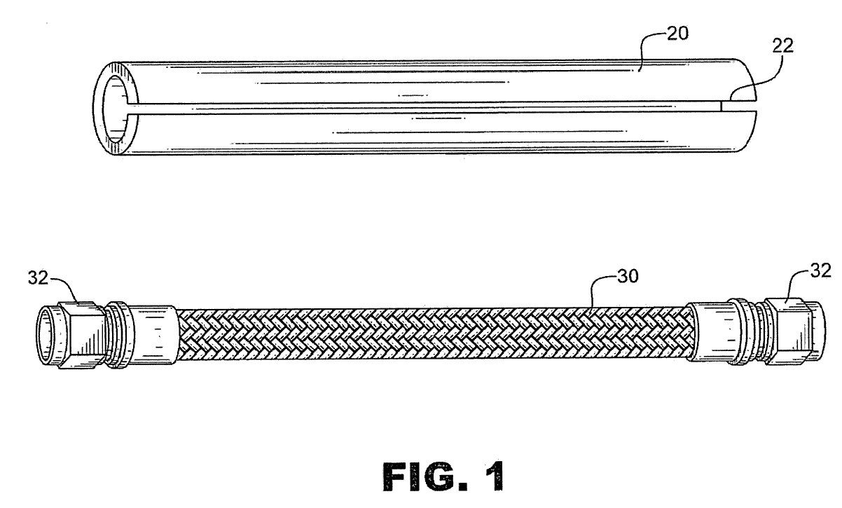

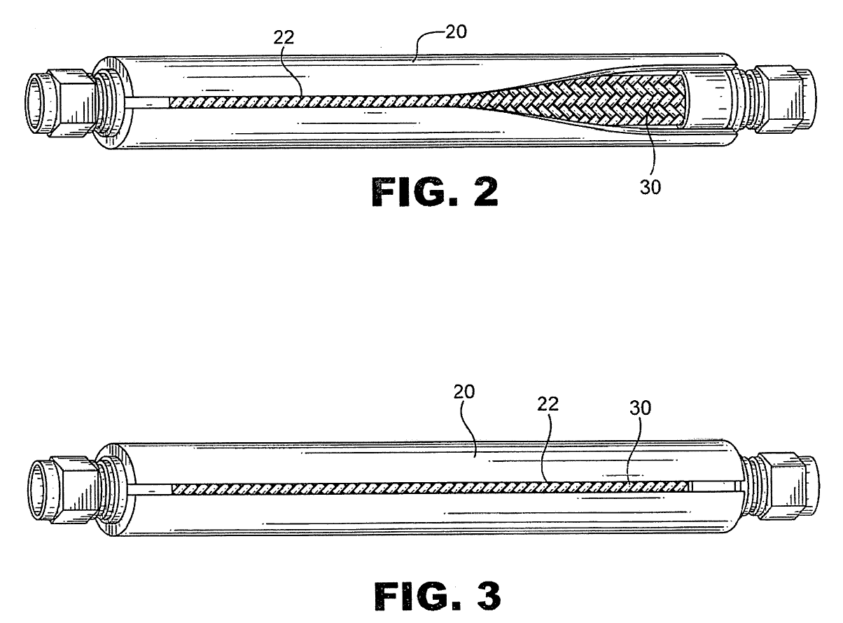

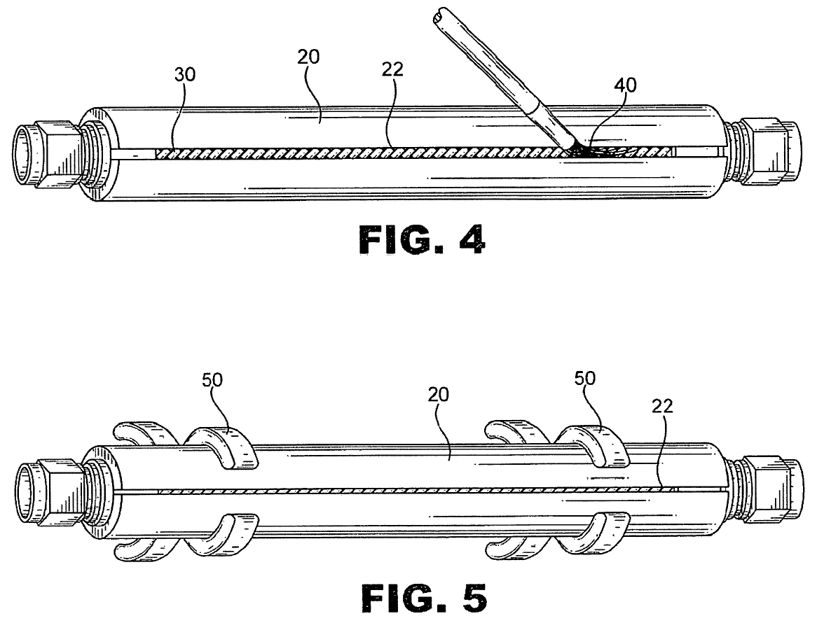

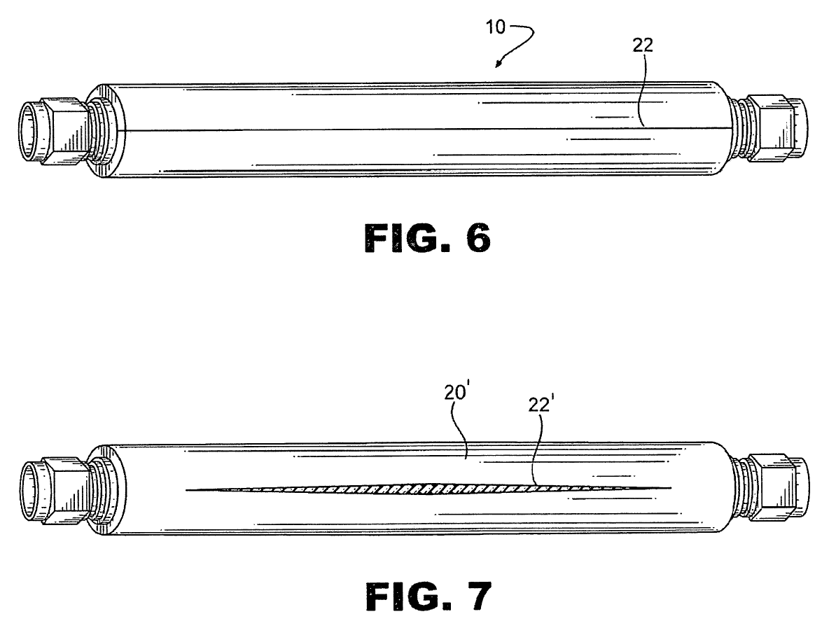

Referring now to FIGS. 1-6, an embodiment of the invention, describing a method for assembling a fire resistant hose assembly 10 is shown. A standard fire resistant sleeve in the form of a tube is cut to a predetermined length for application on a section of hose 30 typically having a fitting 32 attached at either end. The hose 30 as shown is a standard metal braid hose assembly. The fire resistant sleeve is then slit lengthwise across the entire length of the sleeve forming split sleeve 20. This creates an opening or slit 22 in the cylindrical wall of the sleeve 20, such that, the sleeve 20 has a cross-section in the form of the letter “C”. The slit 22 is opened and sleeve 20 is positioned about the hose 30 from the side of the hose 30. The sleeve 20 is then bonded to the hose 30 and the slit 22 is sealed so that the sleeve 20 completely surrounds the hose 30. The bonding of the sleeve 20 to the hose 30 is typically accomplished using a fire resistant adhesive 40, which is applied to the sleeve 20 along the length of the slit 22 and also may be applied directly to the hose 30 along the length of the slit 22. The assembled hose 30 and sleeve 20 are then positioned within a mold 50 so that the sleeve 20 completely surrounds the hose 30 and the slit 22 is completely closed. The assembled hose 30 and sleeve 20 are then pressurized in the mold 50 at a predetermined temperature for a predetermined time until the fire resistant adhesive 40 is cured. Appropriate room temperature vulcanization (RTV) silicone based adhesives may be used. Mold 50 can be any device capable of holding the sleeve in a position where the slit is closed for a period of time in which the adhesive is substantially cured. In FIG. 5, as shown, mold 50 comprises a split die clamp. In at least one embodiment, the sleeve 20 has an inner diameter slightly larger than the outer diameter of the hose 30, particularly so that when the slit 22 is adhesively closed the sleeve 20 will not try to pull open the slit 22 as it would if the sleeve 20 and hose 30 were an interference fit.

While the split sleeve 20 can be made from existing tubular fire resistant sleeves, and it is also anticipated that sleeves 20 can be manufactured with the slit 22 included. It is also anticipated that these split sleeves can be made of any appropriate material that provides the required fire resistance as an outer covering for the hose, that can be slit and sealed, while not requiring the ends to be specially sealed as discussed in the prior art. For example, the sleeve may be extruded silicone. As a further example, the sleeve may be manufactured of a material that includes a mixture of silicone and urethane.

It is noted that the fire resistant adhesive may be applied to one side of the slit 22 or to both sides of the slit 22. Regardless of when assembled, hose 30 and sleeve 20 are pressurized in the mold 50, the adhesive 40 will cover both sides of the slit 22, as well as portions of the hose 30 due to flow of the adhesive 40 when the slit 22 is closed. In this manner, the sleeve 20 is integral with the hose 30 which prevents the sleeve from rotating about the hose 30 as well as preventing the sleeve 20 from moving axially along the hose 30. As previously mentioned, movement of a firesleeve can result in a portion of the hose assembly becoming unprotected.

As the sleeve 20 can be attached to an assembled hose 30 having fittings 32 attached, this also allows any required leak or pressure testing to be completed on the assembled hose 30 prior to installation of sleeve 20.

When the fittings 32 are attached to the hose 30 after the sleeve 20 has been positioned about the hose 30, the slit 22 in the sleeve 20 allows the sleeve 20 to be pulled back away from the fitting 32 so that it is not damaged during the crimping process.

After the fittings 32 are attached, the adhesive 40 can be applied to the slit 22 and hose 30 and the fire resistant hose assembly 10 can be formed as discussed above.

In another embodiment as shown in FIG. 7, a fire resistant sleeve 20′ has a slit 22′ that is spaced from the ends of the sleeve 20′. In this embodiment, the ends of the hose 30′ are positioned through the slit 22′. In this embodiment, the hose 30′ is inserted into the sleeve 20′ prior to assembly of the hose 30′ to the fittings 32. The slit 22′ allows the end of the sleeve 20′ (which is still a tube) to be more easily moved axially along the hose 30′ to enable the sleeve 20′ to be moved away from the fitting 32 when the fitting 32 is attached to the hose 30′ by a crimping process. After the fittings 32 are attached, the adhesive 40 can be applied to the slit 22′ and hose 30′ and the fire resistant hose assembly 10′ can be formed, as discussed above. The use of the sleeve 20′ of this embodiment provides an advantage over the previous embodiment in that the tubular ends of the sleeve 20′ prevent any misalignment of the sleeve ends during the bonding process of the slit as may be possible in the previous embodiment.

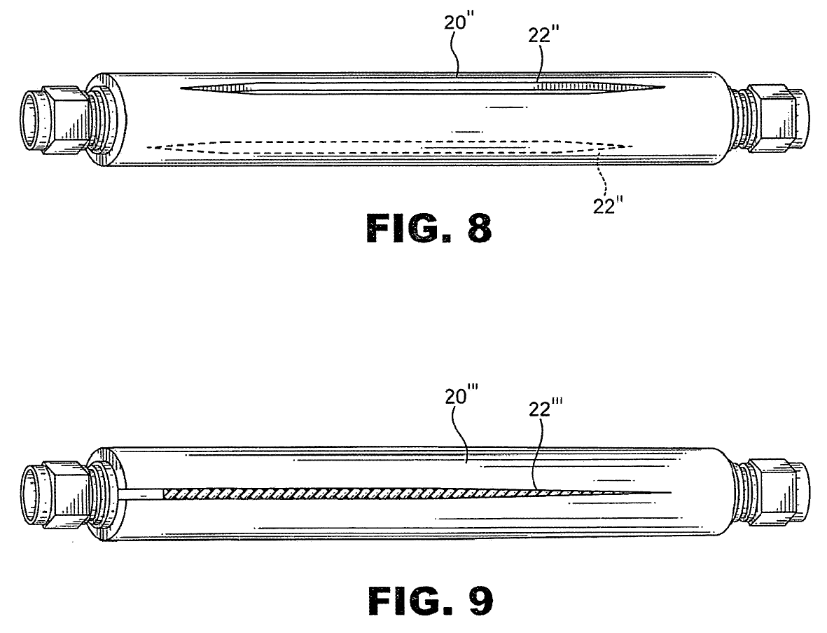

In another embodiment, as shown in FIG. 8, a fire resistant sleeve 20″ comprises two slits 22″ that are axially spaced from the ends of the sleeve 20″ as well as radially spaced from each other along the length of the sleeve 20″. The double slit 22″ provides additional flexibility in allowing the end of the sleeve 20″ to be more easily moved axially along the hose 30′ to enable the sleeve 20″ to be moved away from the fitting 32 when the fitting 32 is attached to the hose 30′ by a crimping process. After the fittings 32 are attached, the adhesive 40 can be applied to both slits 22″ and hose 30′ and the fire resistant hose assembly 10″ can be formed as discussed above.

In still another embodiment, as shown in FIG. 9, a fire resistant sleeve 20′″ comprises a slit 22′″ that is axially spaced from one end of the sleeve 20′″ but extends through the other end of the sleeve 20′″. Such that a configuration could be used when a fitting 32 is attached to only one side of the hose 30.

While in the embodiment shown, the slits 22, 22′, 22″, 22′″, are shown as parallel to the cylindrical axis of the sleeve 20, 20′, 20″, 20′″, the invention is not limited to a particular slit shape or number of slits as such, and it is contemplated that skewed or radial slits may also be used.

Although the principles, embodiments and operation of the present invention have been described in detail herein, this is not to be construed as being limited to the particular illustrative forms disclosed. It will thus become apparent to those skilled in the art that various modifications of the embodiments herein can be made without departing from the spirit or scope of the invention. Accordingly, the scope and content of the present invention are to be defined only by the terms of the appended claims.

What is claimed is:

1. A method for assembling a fire resistant hose assembly, comprising the steps of:
slitting a tubular fire resistant sleeve lengthwise across at least a portion of the length of the sleeve;
inserting a hose into the sleeve through the slit;
applying a fire resistant adhesive along the length of the slit;
applying pressure to the sleeve so that the sleeve completely surrounds the hose; and
curing the adhesive.

2. The method of claim 1, wherein the step of applying a fire resistant adhesive along the length of the slit comprises the step of applying a fire resistant adhesive to at least one side of the slit opening.

3. The method of claim 1, wherein the step of applying a fire resistant adhesive along the length of the slit comprises the step of applying a fire resistant adhesive to both sides of the slit opening.

4. The method of claim 1, wherein the step of applying a fire resistant adhesive along the length of the slit comprises the step of applying a fire resistant adhesive to at least one side of the slit opening and a least a portion of the hose.

5. The method of claim 1, wherein the step of curing the adhesive is accomplished during the step of applying pressure to the sleeve.

6. The method of claim 1, wherein the step of applying pressure to the sleeve is accomplished for a predetermined time and at a predetermined temperature until the step of curing the adhesive is substantially complete.

7. The method of claim 1, wherein prior to the step of applying a fire resistant adhesive along the length of the slit, the method further comprising the steps of:
pulling back the sleeve from an end of the hose; and
attaching a fitting to the hose by a crimping process.

8. The method of claim 7, wherein prior to the step of applying a fire resistant adhesive along the length of the slit, the method further comprising the step of:
pressure testing the fitting and hose.

9. The method of claim 8, wherein the step of slitting the tubular fire resistant sleeve includes the step of stopping of the slit at a distant space from each end of the sleeve.

10. The method of claim 1, wherein prior to the step of inserting a hose into the sleeve, the method further comprising the step of:
attaching at least one fitting to the hose.

11. A method for assembling a fire resistant hose assembly, comprising the steps of:
slitting a tubular fire resistant sleeve lengthwise across at least a portion of the length of the sleeve;
inserting a hose into the sleeve through the slit;
bonding the sleeve to the hose and sealing the slit closed so that the sleeve completely surrounds the hose using a fire resistant adhesive.

12. The method of claim 11, wherein the step of slitting at least a portion of the length of the sleeve comprises the step of slitting a portion of the sleeve spaced from each end of the sleeve.

13. The method of claim 11, wherein the step of slitting at least a portion of the length of the sleeve comprises the step of slitting a portion of the sleeve spaced from at least one end of the sleeve.

14. The method of claim 12, further comprising the step of slitting at least a second portion of the length of the sleeve at a location generally 180° the first slit portion of the sleeve, the second split portion spaced from each end of the sleeve.

15. A fire resistant hose assembly comprising:
a hose;
a hose covering comprising a tubular fire resistant sleeve having a slit lengthwise across at least a portion of the length of the sleeve, the sleeve positioned to completely surround the hose;
wherein the hose covering is adhesively bonded to the hose, and the slit of the sleeve is adhesively sealed.

16. The hose assembly of claim 15, wherein the slit in the sleeve is spaced from each end of the sleeve.

17. The hose assembly of claim 15, wherein the slit in the sleeve is spaced from that least one end of the sleeve.

18. The hose assembly of claim 15, further comprising at least one fitting attached to the hose.

19. The hose assembly of claim 15, wherein the hose covering is the outermost layer of the fire resistant hose assembly.

20. The hose assembly of claim 15, wherein the hose covering is made at least in part of silicone.
